(19) United States
(12) Patent Application Publication
(10) Pub. No.: US 2014/0081621 A1
(43) Pub. Date: Mar. 20, 2014

(54) CHINESE LANGUAGE DISPLAY CONTROL APPARATUS, CHINESE LANGUAGE DISPLAY CONTROL METHOD, AND STORAGE MEDIUM FOR STORING CHINESE LANGUAGE DISPLAY CONTROL PROGRAM

(71) Applicant: Casio Computer Co., Ltd, Tokyo (JP)

(72) Inventor: Muneyuki OGAWA, Iruma-shi (JP)

(73) Assignee: Casio Computer Co., Ltd, Tokyo (JP)

(21) Appl. No.: 13/960,521

(22) Filed: Aug. 6, 2013

(30) Foreign Application Priority Data
Sep. 18, 2012 (JP) 2012-203822

(51) Int. Cl. G06F 17/28

(52) U.S. Cl. CPC G06F 17/28
USPC 704/8

(57) ABSTRACT

The electronic dictionary is equipped with a CPU which performs a control to display a Chinese character string of Chinese language. The CPU performs a control to display a pinyin of the Chinese character string so that the pinyin is correlated to the Chinese character string, and performs a control to detect from the Chinese character string a Chinese character of a certain tone which changes when the Chinese character is combined with a Chinese character of a certain tone, as a tone-change Chinese character, and execute an identifying display of the pinyin which is displayed and corresponds to the tone-change Chinese character.

### CROSS-REFERENCE TO RELATED APPLICATIONS

This application is based upon and claims the benefit of priority from the prior Japanese Patent Application No. 2012-203822 filed on Sep. 18, 2012, the entire contents of which are incorporated herein by reference.

### FIELD OF THE INVENTION

The present invention relates to a Chinese language display control apparatus, a Chinese language display control method, and a storage medium for storing a Chinese language display control program, which display a Chinese pinyin.

### BACKGROUND OF THE INVENTION

Heretofore, a Chinese language display control apparatus which displays a character string of Chinese has been able to display a pinyin of a character at a position corresponding to the character when displaying the character string of Chinese.

Meanwhile, when pronouncing Chinese, there is sometimes a case that a tone change or a tone sandhi occurs depending on a combination of characters, which tone refers to four tones. For example, in the case that there are two successive characters of the third tone, the tone of former character of these characters changes from the third tone to the second tone.

However, according to a conventional Chinese language display control apparatus, even in the case that the tone change occurs depending on the combination of characters, that fact is not displayed and the display content such as the pinyin is not changed, resulting in lowering of learning efficiency.

The object of the present invention is to provide a Chinese language display control apparatus, a Chinese language display control method, and a storage medium for storing a Chinese language display control program, which enables a user, when the tone change occurs depending on the combination of Chinese characters in the character string of Chinese, to easily find that fact.

### SUMMARY

According to an aspect of the present invention, a Chinese language display control apparatus includes: a Chinese character string display control unit which performs a control to display a Chinese character string of Chinese language; a pinyin display control unit which performs a control to display a pinyin of the Chinese character string so that the pinyin is correlated to the Chinese character string; a tone-change detection unit which detects from the Chinese character string a Chinese character of a certain tone which changes when the Chinese character is combined with a Chinese character of a certain tone, as a tone-change Chinese character; and a tone-change pinyin identifying display control unit which performs a control to execute an identifying display of the pinyin which is displayed by the pinyin display control unit and corresponds to the tone-change Chinese character.

According to the present invention, when the tone change occurs depending on the combination of Chinese characters in the character string of Chinese, that fact can be easily found.

### BRIEF DESCRIPTION OF THE DRAWINGS

A more complete understanding of this application can be obtained when the following detailed description is considered in conjunction with the following drawings, in which:

FIG. 1A is a diagram illustrating an overview of an electronic dictionary to which a Chinese language display control apparatus according to the present invention is applied;

FIG. 1B is a diagram illustrating an overview of a tablet personal computer to which a Chinese language display control apparatus according to the present invention is applied;

FIG. 2 is a block diagram illustrating an internal configuration of the electronic dictionary;

FIG. 3 is a flowchart illustrating Chinese language display control processing;

FIG. 4 is a flowchart illustrating tone-change identifying display processing;

FIG. 5 is a flowchart illustrating tone-change detection processing;

FIG. 6A is a diagram illustrating a display content of a display section;

FIG. 6B is a diagram illustrating the display content of the display section;

FIG. 6C is a diagram illustrating the display content of the display section;

FIG. 6D is a diagram illustrating the display content of the display section;

FIG. 7A is a diagram illustrating the display content of the display section;

FIG. 7B is a diagram illustrating the display content of the display section;

FIG. 7C is a diagram illustrating the display content of the display section;

FIG. 7D is a diagram illustrating the display content of the display section;

FIG. 7E is a diagram illustrating the display content of the display section;

FIG. 8A is a diagram illustrating the display content of the display section;

FIG. 8B is a diagram illustrating the display content of the display section;

FIG. 8C is a diagram illustrating the display content of the display section;

FIG. 8D is a diagram illustrating the display content of the display section;

FIG. 8E is a diagram illustrating the display content of the display section;

FIG. 9A is a diagram illustrating the display content of the display section;

FIG. 9B is a diagram illustrating the display content of the display section;

FIG. 9C is a diagram illustrating the display content of the display section;

FIG. 9D is a diagram illustrating the display content of the display section; and

FIG. 9E is a diagram illustrating the display content of the display section.

### DETAILED DESCRIPTION OF THE PREFERRED EMBODIMENT

Hereinafter, an embodiment in the case that a Chinese language display control apparatus of the present invention is applied to an electronic dictionary will be described in detail with reference to the drawings.

[Configuration of External Appearance]

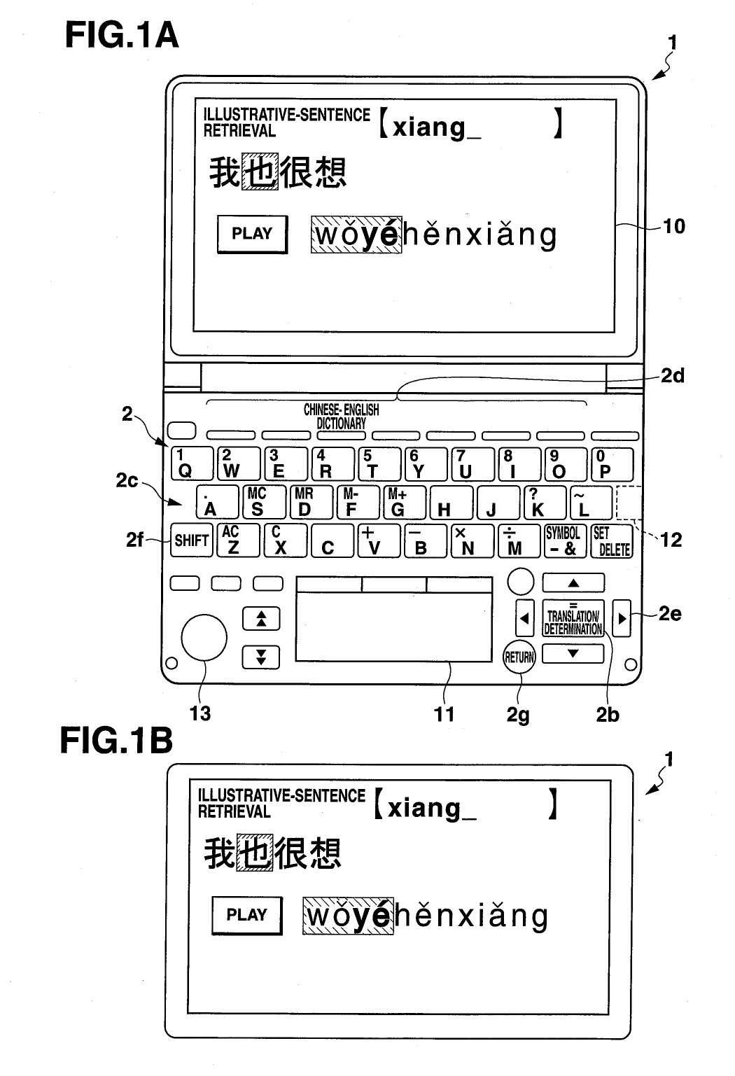

FIG. 1A is a plain view of an electronic dictionary 1.

As illustrated in this drawing, the electronic dictionary 1 includes a main display 10, a sub display 11, a card slot 12, a speaker 13, and a key group 2.

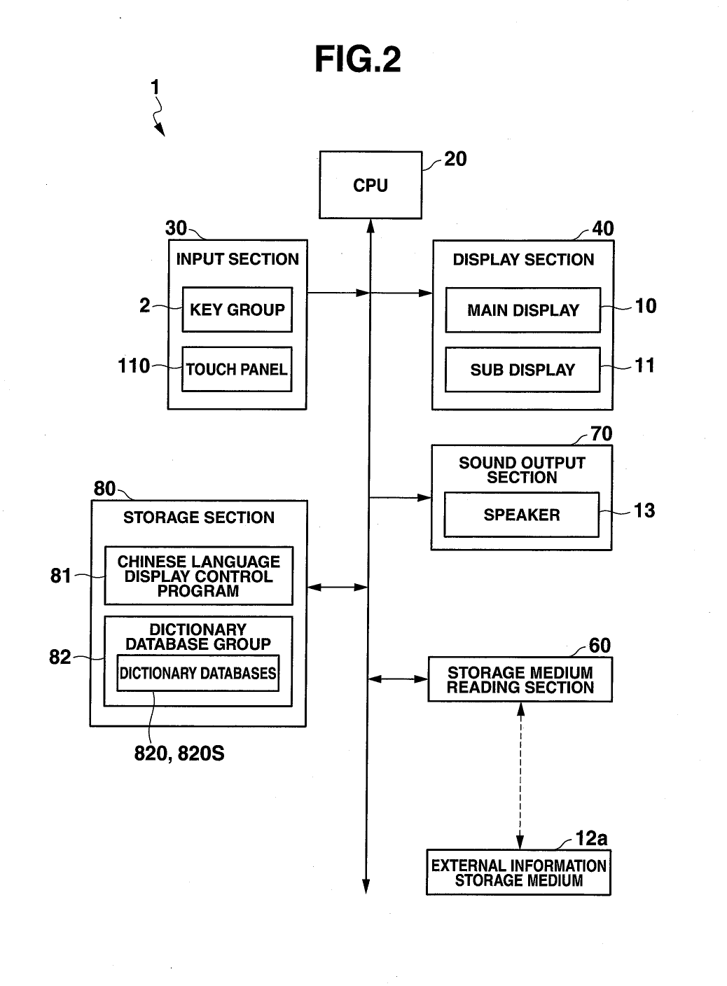

The main display 10 and the sub display 11 are portions, each of which executes a color display of various pieces of data such as characters and codes/marks depending on a user operation, and are composed of a Liquid Crystal Display (LCD), an Electronic Luminescence Display (ELD), or the like. Each of the main display 10 and the sub display 11 according to the embodiment is configured to be integrated with a so-called touch panel 110 (see FIG. 2), and are capable of receiving an operation such as a handwriting input.

The card slot 12 is provided so that an external information storage medium 12a (see FIG. 2) is attachable/detachable to/from the card slot 12, which medium 12a stores various pieces of information.

The speaker 13 is a part which outputs a sound depending on a user operation.

The key group 2 has various keys each of which receives an input by a user for operating the electronic dictionary 1. Concretely, the key group 2 includes a translation/determination key 2b, character keys 2c, dictionary selection keys 2d, cursor keys 2e, a shift key 2f, a return key 2g, etc.

The translation/determination key 2b is used for an execution of retrieval, determination of a direction word, etc. The character keys 2C are used for character inputs by a user, and include keys of “A” to “Z” in the embodiment. The dictionary selection keys 2d are used for selecting a later-described dictionary databases 820, . . . (see FIG. 2).

The cursor keys 2e are used for moving a reversing display portion in a screen, namely a cursor position, and the like, and are capable of designating a direction to the left, right, top and bottom in the embodiment. The shift key 2f is used when setting a Japanese word to a retrieval object, for example. The return key 2g is used when returning to a previously-displayed screen, for example.

### [Internal Configuration]

Next, an internal configuration of the electronic dictionary 1 will be described. FIG. 2 is a block diagram illustrating the internal configuration of the electronic dictionary 1.

As illustrated in this drawing, the electronic dictionary 1 includes a display section 40, an input section 30, a sound output section 70, a storage medium reading section 60, a Central Processing Unit (CPU) 20, and a storage section 80, and the respective sections are configured to be data-communicably connected to one another via a bus.

The display section 40 is configured to include the above-described main display 10 and sub display 11, and displays various pieces of information on the main display 10 and/or sub display 11 on the basis of display signals input from the CPU 20.

The input section 30 is configured to include the above-described key group 2 and touch panel 110, and outputs signals corresponding to positions of the depressed key and/or touch panel 110 to the CPU 20.

The sound output section 70 includes the above-described speaker 13, and causes the speaker 13 to perform a sound output on the basis of sound output signals input from the CPU 20.

The storage medium reading section 60 is equipped with the above-described card slot 12, reads out information from the external information storage medium 12a mounted in the card slot 12, and/or stores information in the external information storage medium 12a.

Here, the external information storage medium 12a is configured to store the dictionary database 820 and the like. Because the dictionary database 820 has the same data structure as the dictionary database 820 in the storage section 80 to be later described, the description thereof is omitted here.

The storage section 80 stores programs and data for implementing various functions of the electronic dictionary 1, which section 80 is a memory functioning as a work space for the CPU 20. In the embodiment, the storage section 80 stores a Chinese language display control program 81, a dictionary data base group 82, etc.

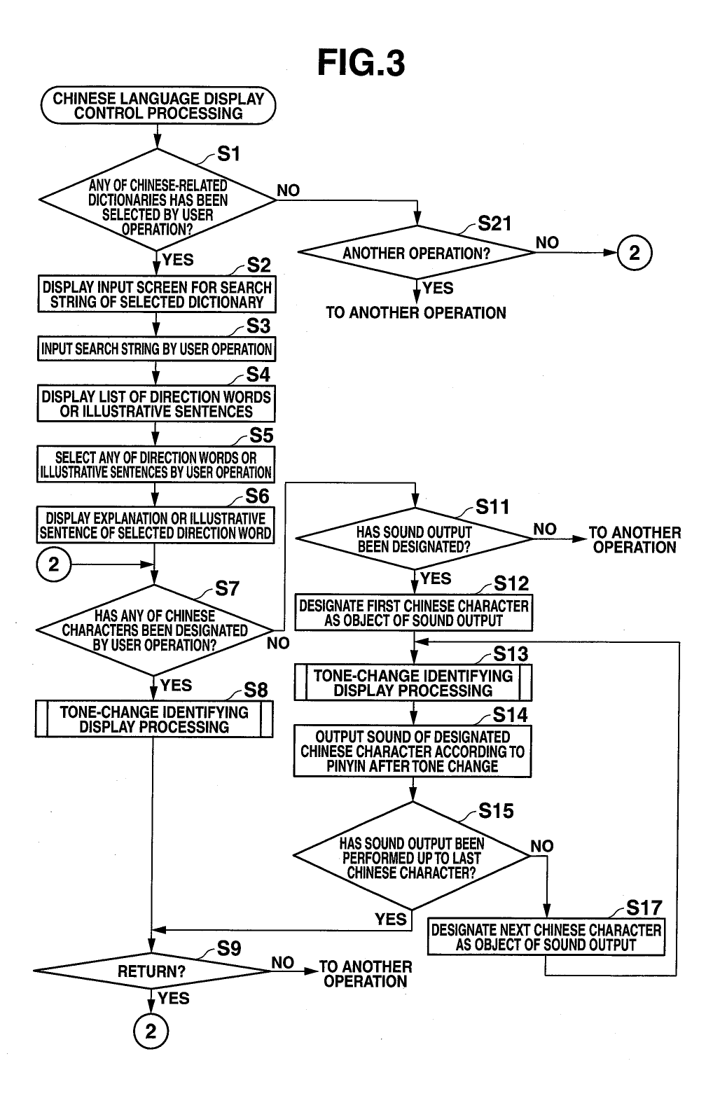

The Chinese language display control program 81 is a program for causing the CPU 20 to execute later-described Chinese language display control processing (see FIG. 3).

The dictionary data base group 82 has a plurality of dictionary data bases 820, . . . , which are relevant to Chinese in the embodiment. Each of these dictionary data bases 820, . . . stores a plurality of pieces of direction word information in which direction words are correlated to pieces of explanatory information thereof, respectively. Incidentally, in the embodiment, the explanatory information includes pieces of audio data of the direction words and the like. Some of the dictionary data bases 820, . . . (the dictionary data base 820 of “Chinese-English dictionary”, for example) use an illustrative sentence as the direction words, and translations of the direction words (illustrative sentence) are used as the explanatory information of the direction words (illustrative sentence) concerned.

The CPU 20 executes processing on the basis of a predetermined program, according to an input instruction, and transfers instructions and/or data to each of the functional sections, whereby the CPU 20 comprehensively controls the electronic dictionary 1. Specifically, the CPU 20 reads out the various programs stored in the storage section 80 correspondingly the operation signal input from the input section 30 or the like, and executes processing according to the programs. The CPU 20 then stores a processing result in the storage section 80, and outputs the processing result to the sound output section 70 and/or the display section 40 as appropriate.

### [Operation]

Next, an operation of the electronic dictionary 1 will be described with reference to the drawings.

### (Chinese Language Display Control Processing)

FIG. 3 is a flowchart illustrating a flow of Chinese language display control processing to be executed by the CPU 20 by reading out the Chinese language display control program 81.

As illustrated in this drawing, in the Chinese language display control processing, the CPU 20 firstly judges whether or not any of the dictionary data bases 820, . . . relevant to Chinese has been selected by a user operation (Step S1).

When it is judged that any of the dictionary data bases 820, . . . relevant to Chinese has not been selected by the user operation in Step S1 (Step S1: No), the CPU 20 judges whether or not another operation has been executed (Step S21).

When it is judged that another operation has been executed in Step S21 (Step S21: Yes), the CPU 20 makes the shift to another operation correspondingly to such operation, and when it is judged that another operation has not been executed (Step S21: No), the CPU 20 makes the shift to Step S7 to be described later.

When it is judged that any of the dictionary data bases 820, . . . relevant to Chinese has been selected by the user operation in Step S1 (Step S1: Yes), the CPU 20 causes the main display 10 to display an input screen for a search string related to the selected dictionary data base 820 (hereinafter referred to as selected dictionary data base 820S) (Step S2). Here, as the search string, a pinyin string can be used in addition to a Chinese character string.

Then, after the search string is input on the basis of the user operation (Step S3), the CPU 20 causes the main display 10 to display a list of direction words (or illustrative sentences) corresponding to the input search string (Step S4).

After that, the CPU 20 selects any of the direction words (or illustrative sentences) on the basis of the user operation (Step S5), and causes the main display 10 to execute a full-screen display of the explanatory information (or an entire text of the selected illustrative sentence and a translation thereof) of the selected direction word (Step S6). At that time, the CPU 20 displays the pinyin while correlating it to at least a part of the Chinese characters.

Next, the CPU 20 judges whether or not a designating operation has been executed with respect to the Chinese character displayed on the main display 10 (Step S7). At that time, in the embodiment, a user performs the designating operation with respect to the Chinese character for which the pinyin thereof is being displayed, among the Chinese characters displayed on the maim display 10.

When it is judged that the designating operation has been executed with respect to the Chinese character in Step S7 (Step S7: Yes), the CPU 20 performs tone-change identifying display processing (Step S8).

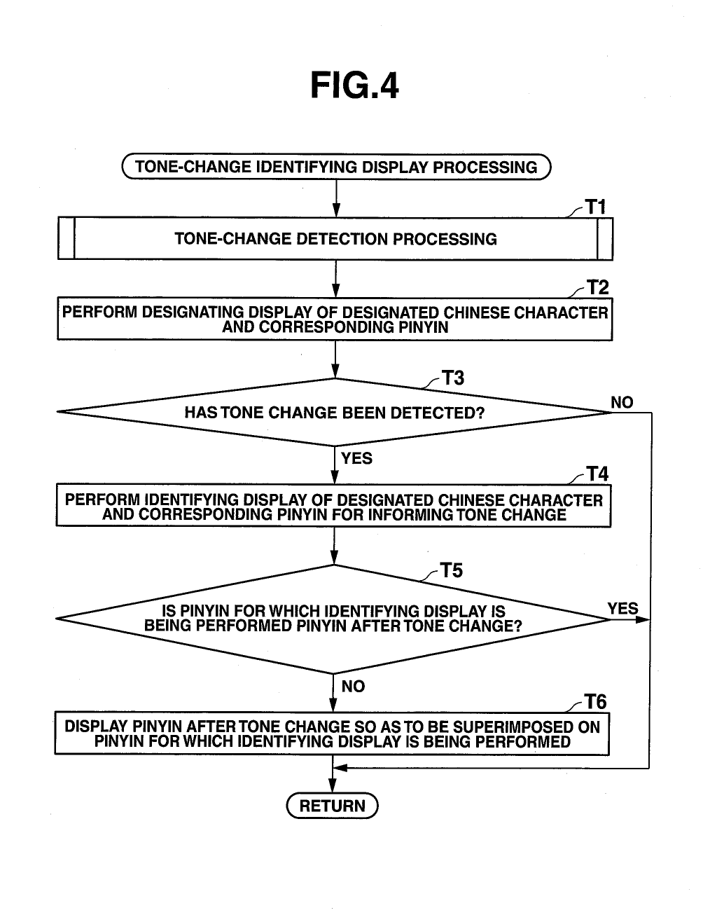

Concretely, as illustrated in FIG. 4, the CPU 20 firstly executes tone-change detection processing in the tone-change identifying display processing (Step T1).

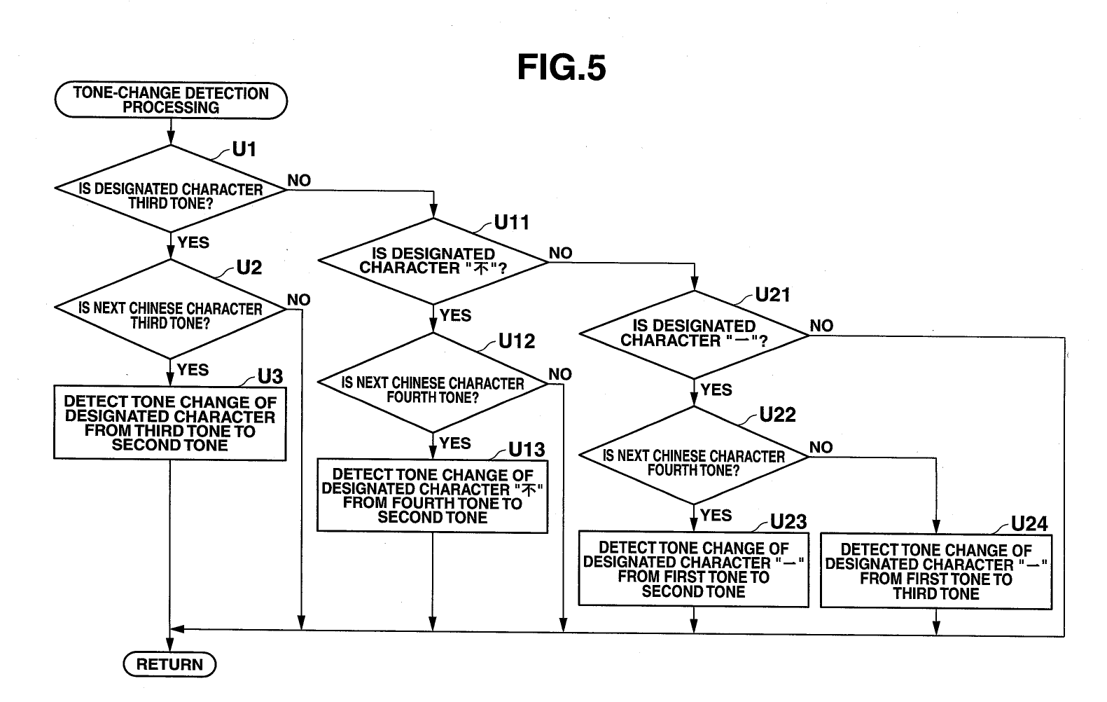

As illustrated in FIG. 5, the CPU 20 judges whether or not the tone of the Chinese character (hereinafter referred to as designated Chinese character) designated in above-described Step S7 (or later-described Steps S12, S17) is the third tone (Step U1).

When it is judged that the tone of the designated Chinese character is the third tone in Step U1 (Step U1: Yes), the CPU 20 judges whether or not the tone of the Chinese character right after the designated Chinese character is the third tone (Step U2).

When it is judged that the tone of the Chinese character right after the designated Chinese character is the third tone (Step U2: Yes), the CPU 20 detects a tone change of the designated Chinese character, concretely, a tone change from the third tone to the second tone (Step U3). By this processing, the Chinese characters are detected as the combination of those of the third tone, and the former Chinese character of the detected Chinese characters of the third tone is detected as a tone-change Chinese character whose tone changes from the third tone to the second tone. Then, the tone-change detection processing is terminated. When it is judged that the tone of the Chinese character right after the designated Chinese character is not the third tone (Step U2: No), the tone-change detection processing is terminated straightly.

When it is judged that the tone of the designated Chinese character is not the third tone in Step U1 (Step U1: No), the CPU 20 judges whether or not the designated Chinese character is “ [symbol] ” (Chinese character having a meaning of “not”) (Step U11).

When it is judged that the designated Chinese character is “ [symbol] ” in Step U11 (Step U11: Yes), the CPU 20 judges whether or not the tone of the Chinese character right after the designated Chinese character “ [symbol] ” is the fourth tone (Step U12).

When it is judged that the tone of the Chinese character right after the designated Chinese character “ [symbol] ” is the fourth tone in Step U12 (Step U12: Yes), the CPU 20 detects the tone change of the designated Chinese character “ [symbol] ”, specifically, detects the tone change from the fourth tone to the second tone (Step U13). By this processing, the Chinese characters are detected as the combination of the designated Chinese character “ [symbol] ” of the forth tone and the Chinese character of the fourth tone, and the former Chinese character “ [symbol] ” of the detected Chinese characters of the fourth tone is detected as the tone-change Chinese character whose tone changes from the fourth tone to the second tone. Then, the tone-change detection processing is terminated. When it is judged that the tone of the Chinese character right after the designated Chinese character “ [symbol] ” is not the fourth tone (Step U2: No), the tone-change detection processing is terminated straightly.

When it is judged that the designated Chinese character is not “ [symbol] ” in Step U11 (Step U11: No), the CPU 20 judges whether or not the designated Chinese character is “ [symbol] ” (Chinese character having a meaning of “one”) (Step U21).

When it is judged that the designated Chinese character is “ [symbol] ” in Step U21 (Step U21: Yes), the CPU 20 judges whether or not the tone of the Chinese character right after the designated Chinese character “ [symbol] ” is the fourth tone (Step U22).

When it is judged that the tone of the Chinese character right after the designated Chinese character “ [symbol] ” is the fourth tone in Step U22 (Step U22: Yes), the CPU 20 detects the tone change of the designated Chinese character “ [symbol] ”, specifically, the tone change from the first tone for the second tone (Step U23). By this processing, the Chinese characters are detected as the combination of the designated Chinese character “ [symbol] ” of the first tone and the Chinese character of the fourth tone, and the former Chinese character “ [symbol] ” of the detected Chinese characters of the first tone is detected as the tone-change Chinese character whose tone changes from the first tone to the second tone. Then, the tone-change detection processing is terminated.

When it is judged that the tone of the Chinese character right after the designated Chinese character “ [symbol] ” is not the fourth tone in Step U22 (Step U22: No), the CPU 20 detects the tone change of the designated Chinese character “ [symbol] ”, specifically, the tone change from the first tone to the third tone (Step U24). By this processing, the Chinese characters are detected as the combination of the designated Chinese character “ [symbol] ” of the first tone and the Chinese character of a tone except the fourth tone, and the former Chinese character “ [symbol] ” of the detected Chinese characters of the first tone is detected as the tone-change Chinese character whose tone changes from the first tone to the third tone. Then, the tone-change detection processing is terminated.

When the above-described tone-change detection processing is terminated, as illustrated in FIG. 4, the CPU 20 then performs a display so that the designated Chinese character and the pinyin thereof are designated (Step T2). Here, the embodiment performs such designating display with a green marker, but the designating display can be performed by another embodiment, for example, by a reversing display.

Next, the CPU 20 judges whether or not the tone change has been detected in the tone-change detection processing (Step T3), and the tone-change identifying display processing is terminated when it is judged that the tone change has not been detected (Step T3: No).

When it is judged that the tone change has been detected in Step T3 (Step T3: Yes), the CPU 20 indicates the fact that the tone change of the designated Chinese character occurs, by performing a display so that the designated Chinese character and the pinyin thereof are identified (Step T4). Here, the embodiment performs such identifying display with a yellow marker, but the identifying display can be performed by another embodiment, for example, by a red color underlining.

Next, the CPU 20 judges whether or not the pinyin for which the identifying display is being performed is the pinyin after the tone change (Step T5), and when it is judged as the pinyin after the tone change (Step T5: Yes), the tone-change identifying display processing is terminated.

When it is judged that the pinyin for which the identifying display is being performed is not the pinyin after the tone change in Step T5 (Step T5: No), the CPU 20 causes the pinyin after the tone change to be displayed so as to be superimposed on the pinyin for which the identifying display is being performed (Step T6), and the tone-change identifying display processing is terminated. Incidentally, in Step T6, the CPU 20 can display the pinyin after the tone change in the vicinity of the pinyin for which the identifying display is being performed.

When the above-described tone-change identifying display processing is terminated, as illustrated in FIG. 3, the CPU 20 then judges whether or not an operation of the return key 2g or an operation for removing the designation of the designated Chinese character has been performed (Step S9).

When it is judged that neither the operation of the return key 2g nor the operation for removing the designation of the designated Chinese character has been performed (Step S9: No), the CPU 20 makes the shift to another processing.

When it is judged that the operation of the return key 2g or the operation for removing the designation with respect to the designated Chinese character has been performed (Step S9: Yes), the CPU 20 cancels the designating display of the designated Chinese character and the pinyin thereof, and makes the shift to the above-described Step S7. At that time, when the pinyin after the tone change is displayed so as to be superimposed on the pinyin for which the identifying display is being performed in Step T6, the CPU 20 cancels the display of the pinyin after the tone change. At that time, in the embodiment, the CPU 20 maintains the identifying display for the pinyin of the designated Chinese character.

When it is judged that the designating operation has not been performed with respect to the Chinese character displayed on the main display 10 in Step S7 (Step S7: No), the CPU 20 judges whether or not an operation for a sound output is performed (Step S11).

When it is judged that the operation for the sound output has not been performed in Step S11 (Step S11: No), the CPU 20 makes the shift to another processing.

When it is judged that the operation for the sound output has been performed in Step S11 (Step S11: Yes), the CPU 20 designates the first Chinese character for which the pinyin thereof is being displayed, among the Chinese characters displayed on the main display 10, as the designated Chinese character which is an object of the sound output (Step S12).

The CPU 20 then performs the tone-change identifying display processing similarly to the above-described Step S8 (Step S13), and causes the speaker 13 to output the sound of the designated Chinese character according to the displayed pinyin (Step S14).

Next, the CPU 20 judges whether or not the sound output has been performed until the sound of the last Chinese character among the Chinese characters displayed on the main display 10 is output (Step S15). When it is judged that the sound output has not been performed up to the last Chinese character (Step S15: No), the CPU 20 cancels the designating display of the designated Chinese character and the pinyin thereof, designates the Chinese character right after the previously-designated Chinese character as the new designated Chinese character (Step S17), and makes the shift to the above-described Step S13. At that time, when the pinyin after the tone change is displayed so as to be superimposed on the pinyin before the tone-change in above-described Step T6, the CPU 20 cancels the display of the pinyin after the tone change. At that time, in the embodiment, the CPU 20 maintains the identifying display with respect to the pinyin of the designated Chinese character.

When it is judged that the sound output has been performed up to the last Chinese character (Step S15: Yes), the CPU 20 makes the shift to above-described Step 9.

### Operation Example

Next, the Chinese language display control processing will be described concretely with reference to the drawings.

### Operation Example 1

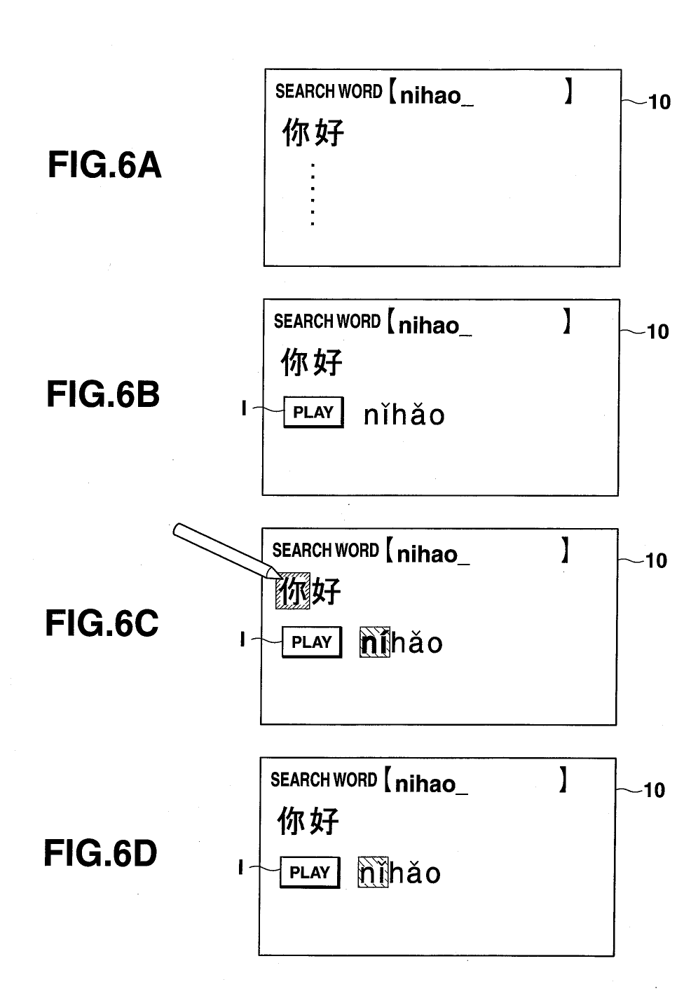

First, when a user selects the dictionary data base 820 of “Chinese dictionary” as the selected dictionary data base 820S (Step S1: Yes), as illustrated in FIG. 6A, a screen for inputting the search string relevant to the selected dictionary data base 820S is displayed on the main display 10 (Step S2).

Then, when the user inputs the search string “nihao”, which are pinyins of Chinese characters “ [symbol] ” (Chinese characters having a meaning of “hello”), in an entry field for direction-word retrieval (Step S3), a list of the direction words such as “ [symbol] ”, which correspond to the input search string “nihao”, is displayed on the main display 10 (Step S4). When the user selects the direction words “ [symbol] ” (Step S5), as illustrated in FIG. 6B, a full-screen display of the explanatory information of the selected direction words is executed on the main display 10 (Step S6). At that time, also a play icon I for outputting the sounds of the direction words is displayed on the main display 10. In FIG. 6B, the illustration of the explanatory information is omitted. In addition, the pinyins of the Chinese characters are displayed so as to be correlated to the Chinese characters “ [symbol] ” which is of the direction words.

Next, as illustrated in FIG. 6C, when the user performs the designating operation (operation to maintain a state of touching a specific position on the screen in this operation example) with respect to the first Chinese character of the direction words, namely the first Chinese character “ [symbol] (ni)” of the direction words “ [symbol] (nihao)” (Step S7: Yes), it is judged that the tone of the designated Chinese character (“ [symbol] (ni)” of “ [symbol] (nihao)) is the third tone (Step U1: Yes), it is further judged that the tone of the Chinese character right after the designated Chinese character is the third tone (Step U2: Yes), and the tone change of the designated Chinese character (“ [symbol] (ni)” of “ [symbol] (nihao)), specifically, the tone change from the third tone to the second tone is detected (Step U3).

Then, after executing the designating display of the designated Chinese character (“ [symbol] (ni)” of “ [symbol] (nihao)) and the pinyin (“ni” of the third tone) thereof with the green marker (Step T2), the identifying display of the designated Chinese character and the pinyin thereof is executed with the yellow marker, whereby the fact that the tone change of the designated Chinese character occurs is informed (Step T4). After that, it is judged that the pinyin (“ni” of the third tone) for which the identifying display is being performed is not the pinyin after the tone change (Step T5: No), and the pinyin after the tone change (“ni” of the second tone) is displayed so as to be superimposed on the pinyin (“ni” of the third tone) for which the identifying display is being performed (Step T6). Incidentally, the illustration of the identifying display of the designated Chinese character is omitted in this operation example 1 and later-described operation example 2. Thus, for example, FIG. 6C illustrates the state of executing the designating display of the designated Chinese character (“ [symbol] (ni)” of “ [symbol] (nihao)) and the identifying display of the pinyin “ni” of the designated Chinese character.

Next, when the user performs an operation (operation to cancel a state of touching a specific position on the screen in this operation example) to remove the designation of the designated Chinese character (Step S9: Yes), as illustrated in FIG. 6D, the designating display of the designated Chinese character and the pinyin thereof is canceled, and at the same time, the display of the pinyin (“ni” of the second tone) after the tone change is canceled. Meanwhile, the identifying display of the designated Chinese character and the pinyin thereof is maintained at that time.

### Operation Example 2

First, when a user selects the dictionary data base 820 of “Chinese dictionary” as the selected dictionary data base 820S (Step S1: Yes), a screen for inputting the search string relevant to the selected dictionary data base 820S is displayed on the main display 10 (Step S2).

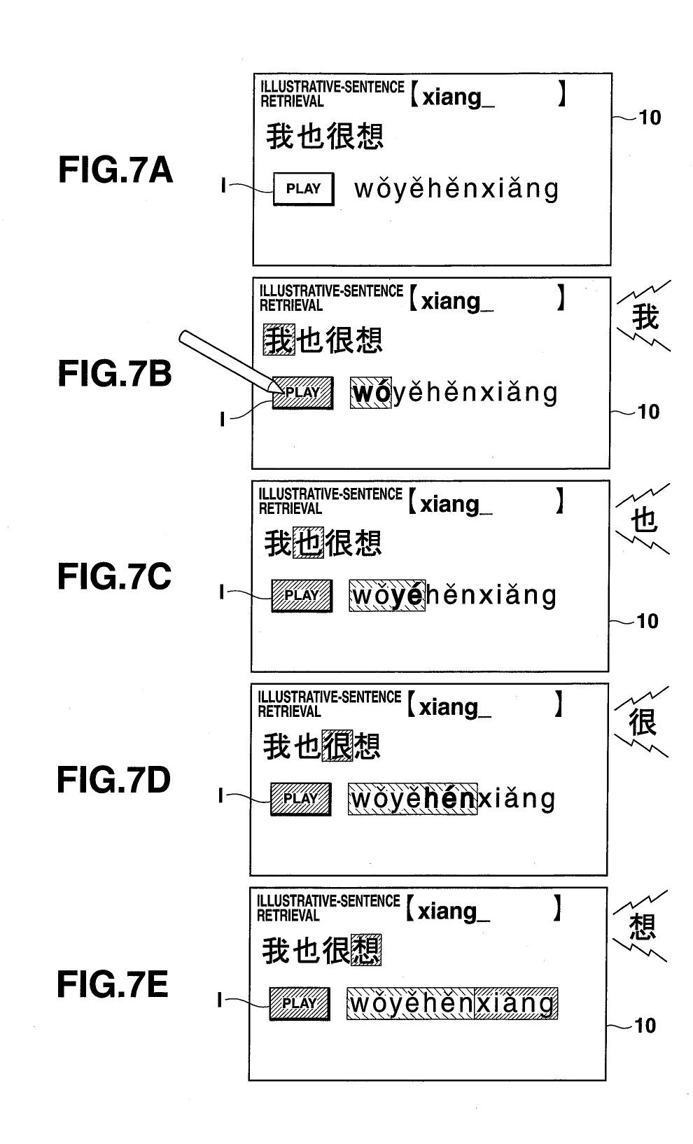

Then, when the user inputs the search string “xiang”, which is pinyin of Chinese character “ [symbol] ” (Chinese character having a meaning of “want/think/miss”), in an entry field for illustrative-sentence retrieval (Step S3), a list of the direction words such as “ [symbol] [symbol] ” (Chinese sentence having a meaning of “I also miss you very much”), which correspond to the input search string “xiang”, is displayed on the main display 10 (Step S4). When the user selects the direction words “ [symbol] ” (Step S5), as illustrated in FIG. 7A, a full-screen display of the explanatory information of the selected direction words “ [symbol] ” is executed on the main display 10 (Step S6). At that time, also a play icon I for outputting the sounds of the direction words is displayed on the main display 10. In FIG. 7A, the illustration of the explanatory information is omitted. In addition, the pinyins of the Chinese characters are displayed so as to be correlated to the Chinese characters “ [symbol] ” which is of the direction words.

Next, as illustrated in FIG. 7B, when the user operates the play icon I to output the sound (Step S11: Yes), the first Chinese character “ [symbol] ” (Chinese character having a meaning of “I”), among the Chinese characters for which the pinyins thereof are being displayed, is designated as the designated Chinese character which is an object of the sound output (Step S12).

Then, it is judged that the tone of the designated Chinese character “ [symbol] ” is the third tone (Step U1: Yes), it is further judged that the tone of the Chinese character “ [symbol] ” (Chinese character having a meaning of “also”) right after the designated Chinese character is the third tone (Step U2: Yes), and the tone change of the Chinese character “ [symbol] ”, specifically, the tone change from the third tone to the second tone is detected (Step U3).

Next, after executing the designating display of the designated Chinese character “ [symbol] ” and the pinyin (“wo” of the third tone) thereof with the green marker (Step T2), the identifying display of the designated Chinese character and the pinyin thereof is executed with the yellow marker, whereby the fact that the tone change of the designated Chinese character occurs is informed (Step T4). After that, it is judged that the pinyin (“wo” of the third tone) for which the identifying display is being performed is not the pinyin after the tone change (Step T5: No), and the pinyin after the tone change (“wo” of the second tone) is displayed so as to be superimposed on the pinyin (“wo” of the third tone) for which the identifying display is being performed (Step T6).

Then, the sound of the designated Chinese character “ [symbol] ” is output according to the displayed pinyin (“wo” of the second tone) (Step S14).

It is then judged that the sound output has not been performed up to the last Chinese character displayed on the main display 10 (Step S15: No), and as illustrated in FIG. 7C, the designating display of the designated Chinese character “ [symbol] ” and the pinyin thereof is canceled and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“wo” of the second tone) after the tone change is canceled.

Then, it is judged that the tone of the designated Chinese character “ [symbol] ” is the third tone (Step U1: Yes), it is further judged that the tone of the Chinese character “ [symbol] ” (Chinese character having a meaning of “very much”) right after the designated Chinese character is the third tone (Step U2: Yes), and the tone change of the designated Chinese character “ [symbol] ”, specifically, the tone change from the third tone for the second tone is detected (Step U3).

Next, after executing the designating display of the designated Chinese character “ [symbol] ” and the pinyin (“ye” of the third tone) thereof with the green marker (Step T2), the identifying display of the designated Chinese character and the pinyin thereof is executed with the yellow marker, whereby the fact that the tone change of the designated Chinese character occurs is informed (Step T4). Then, it is judged that the pinyin (“ye” of the third tone), for which the identifying display is being performed, is not the pinyin after the tone change (Step T5: No), and the pinyin (“ye” of the second tone) after the tone change is displayed so as to be superimposed on the pinyin (“ye” of the third tone) for which the identifying display is being performed (Step T6).

Then, the sound of the designated Chinese character “ [symbol] ” is output according to the displayed pinyin (“ye” of the second tone) (Step S14).

Next, it is judged that the sound output has not been performed up to the last Chinese character displayed on the main display 10 (Step S15: No), and as illustrated in FIG. 7D, the designating display of the designated Chinese character “ [symbol] ” and the pinyin thereof is canceled and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“ye” of the second tone) after the tone change is canceled.

Then, it is judged that the tone of the designated Chinese character “ [symbol] ” is the third tone (Step U1: Yes), it is further judged that the tone of the Chinese character “ [symbol] ” right after the designated Chinese character is the third tone (Step U2: Yes), and the tone change of the designated Chinese character “ [symbol] ”, specifically, the tone change from the third tone to the second tone is detected (Step U3).

Then, after executing the designating display of the designated Chinese character “ [symbol] ” and the pinyin (“hen” of the third tone) thereof with the green marker (Step T2), the identifying display of the designated Chinese character and the pinyin thereof is executed with the yellow marker, whereby the fact that the tone change of the designated Chinese character occurs is informed (Step T4). After that, it is judged that the pinyin (“hen” of the third tone) for which the identifying display is being performed is not the pinyin after the tone change (Step T5: No), and the pinyin (“hen” of the second tone) after the tone change is displayed so as to be superimposed on the pinyin (“hen” of the third tone) for which the identifying display is being performed (Step T6).

Then, the sound of the designated Chinese character “ [symbol] ” is output according to the displayed pinyin (“hen” of the second tone) (Step S14).

Next, it is judged that the sound output has not been performed up to the last Chinese character displayed on the main display 10 (Step S15: No), and as illustrated in FIG. 7E, the designating display of the designated Chinese character “ [symbol] ” and the pinyin thereof is canceled and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“hen” of the second tone) after the tone change is canceled.

Then, after executing the designating display of the designated Chinese character “ [symbol] ” and the pinyin (“xiang” of the third tone) thereof with the green marker (Step T2), the sound of the designated Chinese character “ [symbol] ” is output according to the displayed pinyin (“xiang” of the third tone) (Step S14).

### Operation Example 3

First, when a user selects the dictionary data base 820 of “Chinese-English dictionary” as the selected dictionary data base 820S (Step S1: Yes), a screen for inputting the search string relevant to the selected dictionary data base 820S is displayed on the main display 10 (Step S2).

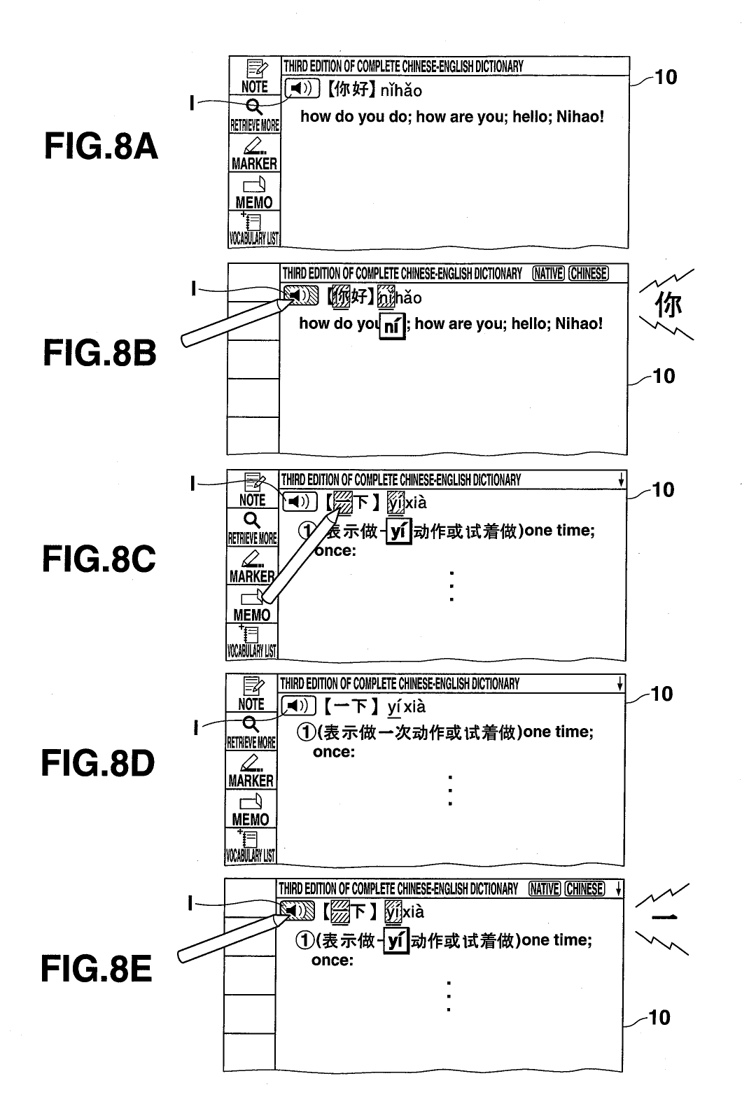

Then, when the user inputs the search string “nihao”, which are pinyins of Chinese characters “ [symbol] ”, in an entry field for direction-word retrieval (Step S3), a list of the direction words such as “ [symbol] ”, which correspond to the input search string “nihao”, is displayed on the main display 10 (Step S4). When the user selects the direction words “ [symbol] ” (Step S5), as illustrated in FIG. 8A, a full-screen display of the explanatory information of the selected direction words is executed on the main display 10 (Step S6). At that time, also a play icon I for outputting the sounds of the direction words is displayed on the main display 10. In FIG. 8A, the illustration of the explanatory information is omitted. In addition, the pinyins are displayed so as to be correlated to the Chinese characters “ [symbol] ” which is of the direction words.

As illustrated in FIG. 8B, when the user operates the play icon I to output the sound (Step S11: Yes), the first Chinese character (“ [symbol] (ni)” of “ [symbol] (nihao)”) of the Chinese characters, for which the pinyins thereof are being displayed, is designated as the designated Chinese character which is an object of the sound output (Step S12).

Then, it is judged that the tone of the designated Chinese character (“ [symbol] (ni)” of “ [symbol] (nihao)”) is the third tone (Step U1: Yes), it is further judged that the tone of the Chinese character “ [symbol] ” right after the designated Chinese character is the third tone (Step U2: Yes), and the tone change of the designated Chinese character (“ [symbol] (ni)” of “ [symbol] (nihao)”), specifically, the tone change from the third tone to the second tone is detected (Step U3).

Next, after executing the designating display of the designated Chinese character (“ [symbol] (ni)” of “ [symbol] (nihao)”) and the pinyin (“ni” of the third tone) thereof with the green marker (Step T2), the identifying display of the designated Chinese character and the pinyin thereof is executed with the red underline, whereby the fact that the tone change of the designated Chinese character occurs is informed (Step T4). Then, after it is judged that the pinyin (“ni” of the third tone) for which the identifying display is being performed is not the pinyin after the tone change (Step T5: No), the pinyin (“ni” of the second tone) after the tone change is displayed, in this operation example, in the vicinity of the pinyin (“ni” of the third tone) for which the identifying display is being performed (Step T6).

Then, the sound of the designated Chinese character (“ [symbol] (ni)” of “ [symbol] (nihao)”) is output according to the displayed pinyin (“ni” of the second tone) (Step S14).

Next, it is judged that the sound output has not been performed up to the last Chinese character displayed on the main display 10 (Step S15: No), the designating display of the designated Chinese character (“ [symbol] (ni)” of “ [symbol] (nihao)”) and the pinyin thereof is canceled, and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“ni” of the second tone) after the tone change is canceled.

Then, after executing the designating display of the designated Chinese character “ [symbol] ” and the pinyin (“hao of the third tone”) thereof with the green marker, the sound of the designated Chinese character “ [symbol] ” is output according to the displayed pinyin (“hao of the third tone”) (Step S14).

### Operation Example 4

First, when a user selects the dictionary data base 820 of “Chinese-English dictionary” as the selected dictionary data base 820S (Step S1: Yes), a screen for inputting the search string relevant to the selected dictionary data base 820S is displayed on the main display 10 (Step S2).

Then, when the user inputs the search string “yixia”, which are pinyins of Chinese characters “ [symbol] ” (Chinese characters having a meaning of “one time/once”), in an entry field for direction-word retrieval (Step S3), a list of the direction words such as “ [symbol] ”, which correspond to the input search string “yixia”, is displayed on the main display 10 (Step S4). When the user selects the direction words “ [symbol] ” (Step S5), as illustrated in FIG. 8C, a full-screen display of the explanatory information of the selected direction words is executed on the main display 10 (Step S6). At that time, also a play icon I for outputting the sounds of the direction words is displayed on the main display 10. In FIG. 8C, the illustration of the explanatory information is omitted. In addition, the pinyins are displayed so as to be correlated to the Chinese characters “ [symbol] ” which is of the direction words.

Next, when the user performs the designating operation (operation to maintain a state of touching a specific position on the screen in this operation example) with respect to the Chinese character “ [symbol] ” (Step S7: Yes), it is judged that the designated Chinese character is “ [symbol] ” (Step U21: Yes), it is further judged that the tone of the Chinese character “ [symbol] ” (Chinese character having a meaning of “next/under/down”) right after the designated Chinese character “ [symbol] ” is the fourth tone (Step U22: Yes), and the tone change of the designated Chinese character “ [symbol] ”, specifically, the tone change from the first tone to the second tone is detected (Step U23).

Then, after executing the designating display of the designated Chinese character “ [symbol] ” and the pinyin (“yi” of the first tone) thereof with the green marker (Step T2), the identifying display of the designated Chinese character and the pinyin thereof is executed with the red underline, whereby the fact that the tone change of the designated Chinese character occurs is informed (Step T4). After that, it is judged that the pinyin (“yi” of the first tone) for which the identifying display is being performed is not the pinyin after the tone change (Step T5: No), and the pinyin (“yi” of the second tone) after the tone change is displayed in the vicinity of the pinyin (“yi” of the first tone) for which the identifying display is being performed (Step T6).

Incidentally, when the pinyin for which the identifying display is being performed is the pinyin (“yi” of the second tone) after the tone change at that time (Step T5: Yes), a new pinyin is not displayed, as illustrated in FIG. 8D.

Next, when the user performs an operation (operation to cancel a state of touching a specific position on the screen in this operation example) to remove the designation of the designated Chinese character (Step S9: Yes), the designating display of the designated Chinese character and the pinyin thereof is canceled. Meanwhile, the identifying display (red underline) of the designated Chinese character and the pinyin thereof is maintained.

Then, as illustrated in FIG. 8E, when the user operates the play icon I to output the sound (Step S11: Yes), the first Chinese character “ [symbol] ” of the Chinese characters, for which the pinyins thereof are being displayed, is designated as an object of the sound output (Step S12).

Similarly to the above-described case, the tone change of the designated Chinese character “ [symbol] ”, specifically, the tone change from the first tone to the second tone is detected (Step U23), and after executing the designating display of the designated Chinese character “ [symbol] ” and the pinyin (“yi” of the first tone) thereof with the green marker (Step T2), the identifying display of the designated Chinese character and the pinyin thereof is executed with the red underline, whereby the fact that the tone change of the designated Chinese character occurs is informed (Step T4). After that, it is judged that the pinyin (“yi” of the first tone) for which the identifying display is being performed is not the pinyin after the tone change (Step T5: No), and the pinyin (“yi” of the second tone) after the tone change is displayed in the vicinity of the pinyin (“yi” of the first tone) for which the identifying display is being performed (Step T6).

Then, the sound of the designated Chinese character “ [symbol] ” is output according to the displayed pinyin (“yi” of the second tone) (Step S14).

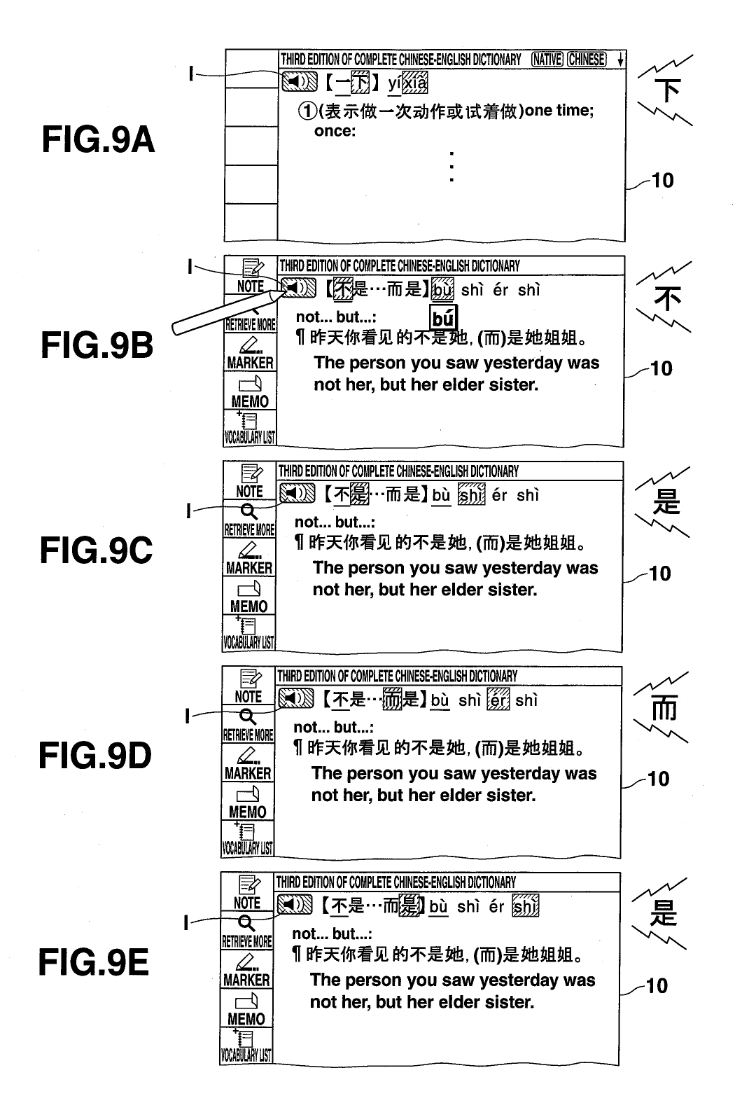

Next, it is judged that the sound output has not been performed up to the last Chinese character displayed on the main display 10 (Step S15: No), and as illustrated in FIG. 9A, the designating display of the designated Chinese character “ [symbol] ” and the pinyin thereof is canceled and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“yi” of the second tone) after the tone change is canceled.

Then, after executing the designating display of the designated Chinese character “ [symbol] ” and the pinyin (“xia” of the second tone) thereof with the green marker, the sound of the designated Chinese character “ [symbol] ” is output according to the displayed pinyin (“xia” of the second tone) (Step S14).

### Operation Example 5

First, when a user selects the dictionary data base 820 of “Chinese-English dictionary” as the selected dictionary data base 820S (Step S1: Yes), a screen for inputting the search string relevant to the selected dictionary data base 820S is displayed on the main display 10 (Step S2).

Then, when the user inputs the search string “bushiershi”, which are pinyins of Chinese characters “ [symbol] [symbol] ” (Chinese characters having a meaning of “not . . . but . . . ”) (Step S3), a list of the direction words such as “ [symbol] ”, which correspond to the input search string “bushiershi”, is displayed on the main display 10 (Step S4). When the user selects the direction words “ [symbol] [symbol] ” (Step S5), as illustrated in FIG. 9B, a full-screen display of the explanatory information of the selected direction words is executed on the main display 10 (Step S6). At that time, also a play icon I for outputting the sounds of the direction words is displayed on the main display 10. In FIG. 9B, the pinyins are displayed so as to be correlated to the Chinese characters “ [symbol] ” which is of the direction words.

Then, after the user operates the play icon I to output the sound (Step S11: Yes), the first Chinese character “ [symbol] ” among the Chinese characters for which the pinyins thereof are being displayed is designated as an object of the sound output (Step S12).

Next, it is judged that the designated Chinese character is “ [symbol] ” (Step U11: Yes), it is further judged that the tone of the Chinese character “ [symbol] ” (Chinese character having a meaning of “be”) right after the designated Chinese character “ [symbol] ” is the fourth tone (Step U12: Yes), and the tone change of the designated Chinese character “ [symbol] ”, specifically, the tone change from the fourth tone to the second tone is detected (Step U13).

Then, after executing the designating display of the designated Chinese character “ [symbol] ” and the pinyin (“bu” of the fourth tone) thereof with the green marker (Step T2), the identifying display of the designated Chinese character and the pinyin thereof is executed with the red underline, whereby the fact that the tone change of the designated Chinese character occurs is informed (Step T4). After that, it is judged that the pinyin (“bu” of the fourth tone) for which the identifying display is being executed is not the pinyin after the tone change (Step T5: No), and the pinyin (“bu” of the second tone) after the tone change is displayed so as to be superimposed on the pinyin (“bu” of the fourth tone) for which the identifying display is being performed (Step T6).

Then, the sound of the designated Chinese character “ [symbol] ” is output according to the displayed pinyin (“bu” of the second tone) (Step S14).

Next, it is judged that the sound output has not been performed up to the last Chinese character displayed on the main display 10 (Step S15: No), and as illustrated in FIG. 9C, the designating display of the designated Chinese character “ [symbol] ” and the pinyin thereof is canceled and the Chinese character “ [symbol] ” right after the previously-designated Chinese character is designated as the new designated Chinese character (Step S17). At that time, the identifying display of the previously-designated Chinese character and the pinyin thereof is maintained, while the display of the pinyin (“bu” of the second tone) after the tone change is canceled.

Then, after executing the designating display of the designated Chinese character “ [symbol] ” and the pinyin (“shi” of the fourth tone) thereof with the green marker (Step T2), the sound of the designated Chinese character “ [symbol] ” is output according to the displayed pinyin (“shi” of the fourth tone) (Step S14).

After that, in a similar way, it is judged that the sound output has not been performed up to the last Chinese character displayed on the main display 10 (Step S15: No), and as illustrated in FIGS. 9D, 9E, the designating display of the designated Chinese character and the pinyin thereof is canceled, each of the Chinese characters “ [symbol] ” (Chinese character having a meaning of “but”), “ [symbol] ” right after the previously-designated Chinese character is designated as the new designated Chinese character (Step S17), and the sound of each of the designated Chinese characters is output according to the displayed pinyin (Step S14).

According to the above-described electronic dictionary 1, as illustrated in Steps T1, T4 of FIG. 4 and in FIGS. 6A to 9E, the Chinese character which should be pronounced while its tone is being changed is detected, from the Chinese character string, as the tone-change Chinese character, and the pinyin corresponding to the tone-change Chinese character is displayed so as to be identified among the displayed pinyins, whereby it is possible to easily find that the tone of the Chinese character changes depending on the combination of the Chinese characters.

Moreover, because the pinyin corresponding to the tone-change Chinese character is changed to the pinyin after the tone change to be displayed as illustrated in Step T6 of FIG. 4 and in FIG. 6C, it is possible to learn a correct pronunciation according to the pinyin after the tone change. Furthermore, because the pinyin corresponding to the tone-change Chinese character is changed to the pinyin after the tone change to be displayed only when the tone-change Chinese character is designated as the designated Chinese character, it is possible to find the fact that there is a difference between a normally-displayed pinyin and the pronunciation thereof. In addition, by cancelling the designated state of the tone-change Chinese character, it is possible to certainly confirm the normally-displayed pinyin in a stationary state.

Incidentally, embodiments to which the present invention can be applied are not limited to the above-described one, and can be changed without departing from the spirits of the present invention.

For example, the Chinese language display control apparatus of the present invention is described as the electronic dictionary 1, but the product to which the present invention can be applied is not limited to such one. For example, in addition to the tablet personal computer as illustrated in FIG. 1B, the present invention can be applied to general electronic devices such as a desktop personal computer, notebook computer, cellular phone, Personal Digital Assistant (PDA), and game machine. In addition, the Chinese language display control program 81 of the present invention can be stored in a memory card attachable/detachable to/from the electronic dictionary 1, a compact disk (CD), and so on.

The embodiments of the present invention are described above, but the scope of the present invention is not limited to the above-described embodiments and includes the scope of the invention described in the claims and the scope of the equivalents thereof.

What is claimed is:

1. A Chinese language display control apparatus comprising:
a Chinese character string display control unit which performs a control to display a Chinese character string of Chinese language;
a pinyin display control unit which performs a control to display a pinyin of the Chinese character string so that the pinyin is correlated to the Chinese character string;
a tone-change detection unit which detects from the Chinese character string a Chinese character of a certain tone which changes when the Chinese character is combined with a Chinese character of a certain tone, as a tone-change Chinese character; and
a tone-change pinyin identifying display control unit which performs a control to execute an identifying display of the pinyin which is displayed by the pinyin display control unit and corresponds to the tone-change Chinese character.

2. The Chinese language display control apparatus according to claim 1, further comprising:
a sound-output control unit which performs a control to execute a sound output of the Chinese character string; and
a Chinese character designating unit which sequentially designates a Chinese character which is an object of the sound output by the sound-output control unit, from Chinese characters contained in the Chinese character string, as a designated Chinese character, wherein
the tone-change pinyin identifying display control unit executes the identifying display of the pinyin corresponding to the tone-change Chinese character when the designated Chinese character is the tone-change Chinese character.

3. The Chinese language display control apparatus according to claim 1, further comprising:
a Chinese character designating unit which designates any of Chinese characters contained in the Chinese character string as a designated Chinese character on the basis of a user operation, wherein
the tone-change pinyin identifying display control unit executes the identifying display of the pinyin corresponding to the tone-change Chinese character when the designated Chinese character is the tone-change Chinese character.

4. The Chinese language display control apparatus according to claim 2, wherein
the pinyin display control unit includes a pinyin-after-tone-change display control unit which performs a control to change the pinyin corresponding to the tone-change Chinese character into the pinyin after the tone change of the tone-change Chinese character to display the changed pinyin only when the tone-change Chinese character is designated as the designated Chinese character.

5. The Chinese language display control apparatus according to claim 2, wherein
the tone-change detection unit detects from the Chinese character string the designated Chinese character as the tone-change Chinese character whose tone changes from the third tone to the second tone when a tone of the designated Chinese character is the third tone and a tone of a Chinese character right after the designated Chinese character is the third tone.

6. The Chinese language display control apparatus according to claim 2, wherein
the tone-change detection unit detects from the Chinese character string the designated Chinese character as the tone-change Chinese character whose tone changes from the fourth tone to the second tone when the designated Chinese character is “ [symbol] ” and a tone of a Chinese character right after the designated Chinese character is the fourth tone.

7. The Chinese language display control apparatus according to claim 2, wherein
the tone-change detection unit detects from the Chinese character string the designated Chinese character as the tone-change Chinese character whose tone changes from the first tone to the second tone when the designated Chinese character is “ [symbol] ” and a tone of a Chinese character right after the designated Chinese character is the fourth tone.

8. The Chinese language display control apparatus according to claim 2, wherein
the tone-change detection unit detects from the Chinese character string the designated Chinese character as the tone-change Chinese character whose tone changes from the first tone to the third tone when the designated Chinese character is “ [symbol] ” and a tone of a Chinese character right after the designated Chinese character is a tone except the fourth tone.

9. A method for controlling a display of a Chinese language in a computer, the method comprising steps of:
performing a control to display a Chinese character string of Chinese language;
performing a control to display a pinyin of the Chinese character string so that the pinyin is correlated to the Chinese character string;
detecting from the Chinese character string a Chinese character of a certain tone which changes when the Chinese character is combined with a Chinese character of a certain tone, as a tone-change Chinese character; and
performing a control to execute an identifying display of the pinyin which is displayed so as to be correlated to the Chinese character string and corresponds to the tone-change Chinese character.

10. A non-transitory storage medium which stores a Chinese language display control program for causing a computer to exert functions of:
performing a control to display a Chinese character string of Chinese language;
performing a control to display a pinyin of the Chinese character string so that the pinyin is correlated to the Chinese character string;
detecting from the Chinese character string a Chinese character of a certain tone which changes when the Chinese character is combined with a Chinese character of a certain tone, as a tone-change Chinese character; and
performing a control to execute an identifying display of the pinyin which is displayed by the function of performing the control to display the pinyin and corresponds to the tone-change Chinese character.
